(19) United States
(12) Patent Application Publication
(10) Pub. No.: US 2006/0092040 A1
(43) Pub. Date: May 4, 2006

(54) Detecting activity of RFID objects via multiple tags/readers

(76) Inventors: Kenneth P. Fishkin, Seattle, WA (US); Matthai Philipose, Seattle, WA (US); Bing Jiang, Seattle, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/980,515

(22) Filed: Nov. 2, 2004

(51) Int. Cl. H04Q 5/22

(52) U.S. Cl. 340/825.49; 340/10.1; 340/539.13

(57) ABSTRACT

Various embodiments or the invention may use changes in the quantity of responses received from an RFID-tagged object to derive parameters that indicate probably movement or the object. In some embodiments, multiple RFID tags and/or multiple RFID readers may be used in conjunction with one another to further refine the probability of movement and/or to indicate the probability of a particular type of movement.

### BACKGROUND

Radio frequency identification (RFID) tags have become commonplace for various types of use, such as inventory control, toll road collection, controlled access badges, etc. In general, an RFID tag is an electronic device that uses radio frequency wireless communication to transfer information (typically, but not exclusively, a unique ID) to an interrogator. Typically (but not necessarily) the tag is powered from the received energy of a received radio signal, and it uses that received energy to power itself and transmit a sequence that identifies the tag. RFID readers are devices that transmit the energizing signal and receive the identification sequences from RFID tags within range. Further processing may be performed once the identification number(s) is identified in this manner, either by the reader or by another device in communication with the reader. Although the technology has improved in various ways, in many instances the radio exchange is still generally a simple binary operation: either an identification number is received by the reader or it is not. In a conventional system, this binary operation only provides information that the tagged item is within range of the RFID reader, but provides no information about possible movement of the tagged item within that range.

### BRIEF DESCRIPTION OF THE DRAWINGS

The invention may be understood by referring to the following description and accompanying drawings that are used to illustrate embodiments of the invention. In the drawings:

FIG. 1 shows a system in which an RFID reader may detect motion in an RFID tag, according to an embodiment of the invention.

FIG. 2 shows and example of response rates with time, according to an embodiment of the invention.

FIG. 3 shows a system with an object having multiple RFID tags, according to an embodiment of the invention.

FIG. 4 shows s system comprising multiple RFID readers to read the same RFID tag, according to an embodiment of the system.

FIG. 5 shows a flow diagram of a method of determining an indication of movement of an object, according to an embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, the different embodiments described may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

The invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive those signals, etc.), and others.

Various embodiments of the invention may use changes in the nature of the response received from an RFID-tagged object to derive parameters that indicate probable movement of the object. In some embodiments, multiple RFID tags and/or multiple RFID readers may be used in conjunction with one another to further refine the probability of movement and/or to indicate the probability of a particular type of movement.

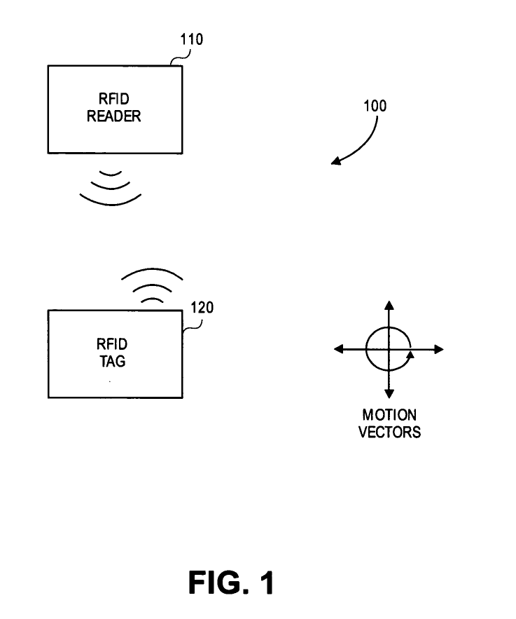

FIG. 1 shows a system in which an RFID reader may detect motion in an RFID tag, according to an embodiment of the invention. In a typical example, the RFID tag would be affixed to another object, and motion of the object would be inferred from detecting motion of the RFID tag. Since the technique might apply to any feasible object to which an RFID tag can be affixed or embedded, for the sake of simplicity a description of the object has not been included. In system 100, RFID reader 110 may transmit a radio frequency signal that may be received by RFID tag 120. If the signal received by RFID tag 120 contains sufficient energy, RFID tag 120 may transmit a modulated signal back to RFID reader 110, the modulation being such as to permit the RFID reader to identify the RFID tag. In some embodiments, the RFID tag may transmit by modulating the received signal and ‘reflecting’ the modulated signal from its own antenna, although other embodiments may use other techniques (e.g., powering the transmission entirely from energy within the RFID tag, etc.).

For simplicity in the drawings, the illustrated signals in FIG. 1 (and in some other figures) appear to be directional, i.e., the signal from the RFID reader appears to be transmitted only in the general direction of the RFID tag, and the signal from the RFID tag appears to be transmitted only in the general direction of the RFID reader. However, in some embodiments the transmitted signals from either or both devices may be relatively multidirectional or relatively omnidirectional due to various reasons, such as but not limited to the shape and orientation of the transmitting antenna. Similarly, the strength of the received signal may depend on various factors, such as but not limited to the shape and orientation of the receiving antenna with respect to the direction of the incoming signal.

FIG. 1 also shows possible motion vectors for RFID tag 120. RFID tag 120 may move laterally by moving sideways with respect to RFID reader 110 (shown as a left/right vector in the drawing), RFID tag 120 may move laterally by moving closer to or farther from RFID reader 110 (shown as an up/down vector in the drawing), and RFID tag 120 may rotate without changing its distance or direction from RFID reader 110 (shown as a circular vector in the drawing). Motion may also be any combination of these. Although motion vectors are only shown for two dimensional space, these vectors may easily be extended to three dimensional space. In some configurations, moving a small distance to the left or right may have little effect on the strength of the signals received and/or transmitted by RFID tag 120. However, since the strength of transmitted signals tends to vary with distance, moving closer to or farther from the reader may increase/decrease the received signal strength at the RFID tag, which may have a corresponding effect of the strength of the signal transmitted from the RFID tag, and a further increase/decrease on the strength of the signal received by the RFID reader.

In a related manner, rotating the RFID tag may change the orientation of its antenna, which may change the perceived strength of the signal received from the direction of the RFID reader. For example, if the antenna is initially oriented such that obtains maximum reception from the direction of the RFID reader, and then rotates 90 degrees so that it obtains much weaker reception, the energy received by the RFID tag may be significantly reduced. The strength of the signal transmitted by the RFID tag may be similarly directional, so that after rotation it no longer sends its maximum signal in the direction of the RFID reader.

Although either or both of the RFID tag and RFID reader may be moved, their relative distance and orientation from each other may be the primary factors in signal strength, and this orientation is described herein with respect to movement of the RFID tag only. Further, only a two dimensional orientation between the RFID reader and the RFID tag are described herein, although three dimensional motion may be obtained. It should be obvious to a person of ordinary skill in the art to extend the principles described herein to three dimensions and to movement by either or both of the tag and the reader.

In some embodiments the strength of the signal received by the RFID tag 120 is not directly measurable, although it may affect the strength of the signal transmitted from the RFID tag 120. In some RFID systems, an RFID tag responds to any receipt of the proper signal (e.g., a carrier wave of the correct frequency), provided the received energy is sufficient to power the circuitry of the RFID tag. The strength of that response may or may not be strong enough to be detected by the RFID reader. As a result, the reader may perceive only a binary result: either it receives a response identifying the RFID tag or it does not. Other than proximity and orientation, many external factors may affect whether a response is received. Such factors may include, but are not limited to: reflections of signals off nearby objects, signals passing through objects between the transmitter and receiver, interference caused by other signals, electrostatic disturbances, etc. Because of such factors, some signals transmitted from an RFID reader may not result in a response from a particular RFID tag, and some of the responses from an RFID tag may not be detected by the RFID reader, even in the absence of movement by the reader and the tag. To overcome this problem, the reader may transmit a signal for an extended period of time (or a series of transmitted signals over the period of time), monitor the number of responses received, compare that number to a reference number (such as a theoretical maximum number of responses that might be obtained) to obtain a value that is a statistical indicator of the relevant signal strengths. If this process is repeated over a sufficiently large period of time, so that a sufficiently large number of indicators are determined over that period of time, a change in this indicator may indicate that the RFID tag has moved relative to the RFID reader and/or that external influences that affect signal strength have changed.

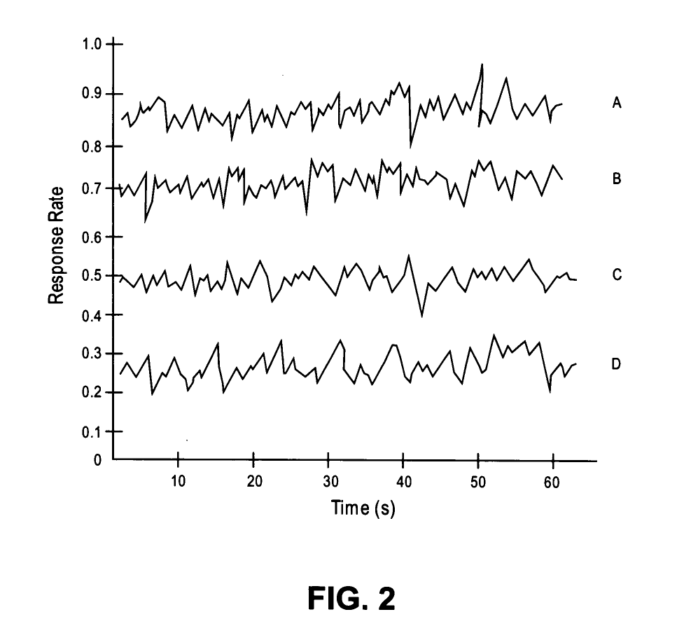

FIG. 2 shows an example graph of response rates with time, according to an embodiment of the invention. In some embodiments the RFID reader may make a series of short transmissions, while in other embodiments the RFID reader may transmit a continuous signal for a defined period of time. In either case, under ideal circumstances the RFID tag may respond some theoretical maximum number of times during the time interval if the reader and tag are close enough and there are no sources of interference or signal degradation. This number may represent a reference value. The actual number of responses received during operation may be divided by this reference value to produce a response rate. If the actual number of responses received matches the reference value, a response rate of 1.0 may be obtained. Conversely, if no responses are detected by the reader during the designated time, a response rate of 0.0 would be obtained. Note: although this example uses a theoretical maximum value as a reference value and a response rate range of 0.0-1.0, it would be obvious to a person of ordinary skill in the art that other reference values may be used and other ranges obtained by simply using other mathematical treatments.

The graph of FIG. 2 shows four traces, each trace representing a series of response rates as those response rates change over an extended period of time for an RFID tag that doesn't move. The period of time used to determine a single value for the response rate may be too small to be shown on this graph (e.g., a fraction of a second), but the variation of the value for successive response rates can be clearly seen by the jagged traces. Various factors, such as those previously described, may cause the response rate to vary as shown even though the RFID tag and RFID reader are not moving with respect to each other. Therefore, a statistical treatment of the response rate may be used to determine a more stable value for longer periods of time. For the graph shown, those more stable values are approximately 0.85, 0.7, 0.5, and 0.25, respectively. In one example, the four traces shown in FIG. 2 may represent four different distances between the RFID tag and the RFID reader. If a tag moved farther away, from the position of A to the position of B, the value of the response rate would be expected to change from the range shown for A to that shown for B. Movement even farther away would produce the response rates in the ranges shown for C and D, respectively.

In another example, the four ranges A-D may represent different orientations of the antenna of the RFID tag, with an antenna substantially facing the RFID reader producing the range of response rates shown for A, while turning the antenna progressively away from the RFID reader would produce the ranges shown for B, C, and D, respectively. As can be seen, a response rate of 1.0 is a theoretical maximum and no further improvement in signal strength via closer distance or improved antenna orientation may be detectable through this technique. Similarly, a response rate of 0.0 is a theoretical minimum, and no further reduction in signal strength via greater distance or degraded antenna angle may be detectable through this technique.

Using the described techniques, all response rates may be expected to fall between 0.0 and 1.0, inclusive. The period of time that is used to determine a single value for response rate may represent a tradeoff between various factors—if the time period it too short, the number obtained may not be statistically accurate, but if the time period is too long, the system may not be able to detect movement quickly enough. Similarly, the time period used to determine the trend of the response rates may also be a tradeoff, for similar reasons. Different applications may require different periods of time to achieve the desired results.

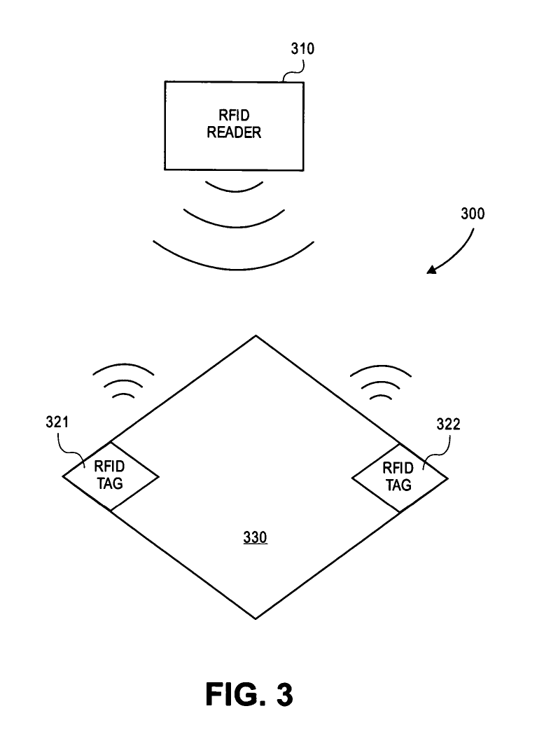

FIG. 3 shows a system with an object having multiple RFID tags, according to an embodiment of the invention. In system 300, a single RFID reader 310 is shown (similar to FIG. 1), but an object 330 is shown with multiple RFID tags 321 and 322. As in FIG. 1, the radio transmissions may be multidirectional or omnidirectional, but for simplicity only the transmissions toward the RFID reader and RFID tags are illustrated. RFID reader 310 may transmit signals to RFID tags 321, 322, and receive responses from RFID tags 321, 322 in the manner previously described. The use of two RFID tags on a single object 330 may allow an improvement in detection of movement by object 330, as compared to the single RFID tag technique. In some embodiments, more that two RFID tags may be affixed to a single object to further improve detection of motion, by expanding the techniques described for two RFID tags.

For example, an increase in the response rate for a single RFID tag might indicate either that the attached object is moving closer, or that the object is rotating such that the antenna angle is improved, but it may be difficult to determine which. In the illustrated example of FIG. 3, if both tags show an improved response rate, by approximately the same amount, it may be inferred that the object is moving closer without rotating. A reduction in the response rate for both tags, by approximately the same amount, may imply that the object is moving farther away without rotating. On the other hand, if one RFID tag shows an increase in response rate, while the other shows a decrease, it may be inferred that either: 1) one tag is moving closer while the other tag is moving farther away, a combination that would imply rotation of the object 330, or 2) both tags are rotating, a combination that would also imply rotation of the object 330. Imposing various restrictions on system behavior may improve the dependability of the inferred results. For example, if an RFID-tagged object is restricted to only one type of motion, e.g., to only lateral movement or only rotation, specific antenna configurations may provide even better motion information for those limited circumstances.

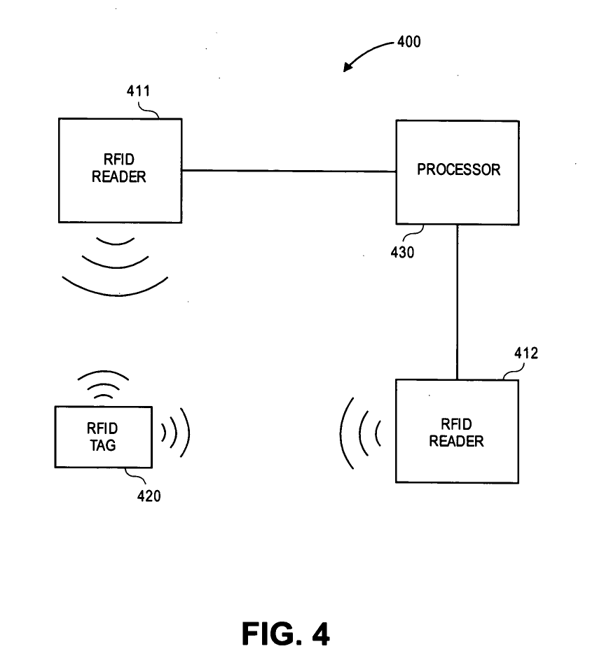

FIG. 4 shows a system comprising multiple RFID readers to read the same RFID tag, according to an embodiment of the system. As before, propagated signals are only shown in the directions of interest. In the illustrated system 400, RFID reader 411 and RFID reader 412 may each receive responses from RFID tag 420, and the results of those responses may be coordinated to improve the determination of motion by RFID tag 420. For example, indications of RFID tag motion derived from readings by RFID reader 411, and indications of RFID tag motion derived from readings by RFID reader 412, may be coordinated to derive indications of the type of motion of RFID tag 420.

In some embodiments, RFID readers 411, 412 may be at approximate right angles to one another with respect to RFID tag 420, although other embodiments may not be so limited. In the illustrated example, RFID reader 411 and RFID reader 412 may pass information to processor 430 for combined analysis, although the various embodiments of the invention are not limited in this manner. The position of processor 430 may take various forms. For example, processor 430 may be located with RFID reader 411, with RFID reader 412, or may be external to both RFID readers 411 and 412. The connection between each RFID reader and processor 430 may take any feasible form, such as direct connection, shared bus, wired and/or wireless telecommunications, a combination of techniques, etc. In some embodiments each RFID reader may derive its own response rates and pass those response rates to processor 430, but other embodiments may use other techniques (e.g., each RFID reader may pass the detected tag identifications to processor 430, which determines response rates and compares those ratios for both RFID readers.

In an example of the type of coordination that various embodiments might use, if RFID reader 411 detects an increasing response rate while RFID reader 412 detects no change in response rate, it may be inferred that RFID tag 420 is moving laterally towards RFID reader 411, but moving at right angles to RFID reader 412. Rotating RFID tag 420 might increase the response rate seen by one reader while decreasing the response rate seen by the other reader (as the antenna turns toward one reader but away from the other reader). However, various directions of lateral motion might give the same results. To resolve such ambiguities, additional RFID readers may be used. In one embodiment, three RFID readers may be used, located in orthogonal directions from RFID tag 420 such that the directional vectors between the RFID tag and the three RFID readers correspond approximately to x, y, and z axes at mutual right angles. Additional readers may also be used to further reduce ambiguities.

Because the signals from the various RFID readers might sometimes interfere with one another to produce confusing results, various techniques may be used to reduce such interference. Such techniques may comprise one or more of the following, but may not be limited to these:

1) The RFID readers may coordinate their transmissions so that only one reader is transmitting at any given time.

2) Each response from an RFID tag may be received and counted by more than one RFID reader, regardless of which RFID reader the RFID tag is responding to. As long as responses to one reader are not mingled with responses to another reader, the resulting response rates should remain meaningful. In some operations, this technique may be preferable. For example, if the location and/or antenna configuration of RFID tag 420 is such that its responses to RFID reader 411, as received by RFID reader 411, are saturated at 1.0, and its responses to RFID reader 412, as received by RFID reader 412, are at 0.0, these rates may change little or not at all when RFID tag 420 moves. However, if the response rates to RFID reader 411, as received by RFID reader 412, and the responses to RFID reader 412, as received by RFID reader 411, are both within the more useful range between 0.2 and 0.8, then changes in the response rates in either direction could be detected.

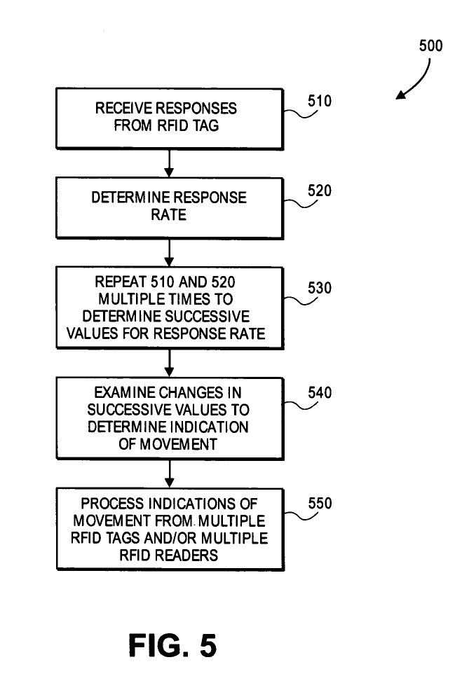

FIG. 5 shows a flow diagram of a method of determining an indication of movement of an object, according to an embodiment of the invention. In flow chart 500, multiple responses from an RFID tag may be received at 510. At 520 a response rate may be determined for those responses. In some embodiments, the response rate may be determined by a procedure that includes dividing the number of responses received by a reference value, such as but not limited to a reference value that represents a theoretical or actual maximum for the number of responses that could have been received. At 530, the operations of receiving at 510 and determining at 520 may be repeated multiple times to determine a series of values for the response rate, with each value representing a different period of time for receiving the responses at 510. In some embodiments the different periods of time may be non-overlapping, with each response contributing to no more than one value of response rate, although other embodiments may not be limited in this manner (e.g., time periods may overlap, with at least one response contributing to more than one calculation of response rate). In some embodiments the time periods may occur at regular intervals, while in other embodiment the time periods may occur at irregular intervals.

At 540 the multiple values for response rate may be compared to one another, and/or to some other reference value, to detect changes in those values, with a sufficient change in the values providing an indication that the RFID tag has moved. Statistical treatments may be used in this comparison process to improve the probability that the observed changes actually represent movement rather than other external influences such as random noise, interference, reflections, movement of other external objects, etc.

While 510 through 540 may represent a process involving responses received from a single RFID tag using a single RFID reader, the results may be improved by using multiple RFID tags and/or multiple RFID readers to get multiple sets of response rates, and processing those multiple sets at 550 to get improved results as compared with the results obtained from a single RFID tag and RFID reader. For example: 1) a single RFID reader may receive responses from multiple RFID tags at different places on the same object to derive multiple sets of response rates, 2) multiple RFID readers at different locations may receive responses from a single RFID tag to derive multiple sets or response rates, or 3) multiple RFID readers at different locations may receive responses from multiple RFID tags at different places on the same object to derive multiple sets of response rates. For each reader/tag combination, a separate indication of motion may be determined based on the differences in the associated response rates, and the separate indications of motion may then be processed to determine a combined indication of motion As before, statistical treatments may be used to improve the probability that the observed responses represent actual movement of the object rather than that lateral movement may be distinguished from rotation.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. An apparatus, comprising
a device to determine an indication of movement of an object, the object comprising a first radio frequency identification (RFID) tag, based on a change in successive values of a first parameter, the values of the first parameter to be determined by:
receiving a first quantity of responses from the first RFID tag by a first RFID reader during a first time period;
deriving the value of the first parameter, the value indicative of the first quantity; and
repeating the operations of receiving the first quantity and deriving the value of the first parameter to determine additional ones of the values for time periods successive to the first time period.

2. The apparatus of claim 1, wherein the value of the first parameter is indicative of a ratio of the first quantity to a first reference value.

3. The apparatus of claim 1, wherein the movement consists of at least one of lateral motion and rotation.

4. The apparatus of claim 1, the object further comprising a second RFID tag, wherein the device is further to determine the indication of the movement of the object based at least in part on a change in successive values of a second parameter, the second parameter associated with a second quantity of responses received from the second RFID tag, the values of the second parameter derived by:
receiving a second quantity of responses from the second RFID tag by the first RFID reader during a second time period;
deriving the value of the second parameter, the value indicative of the second quantity; and
repeating the operations of receiving a second quantity and deriving the value of the second parameter to determine additional ones of the values for the second parameter for time periods successive to the second time period.

5. The apparatus of claim 4, wherein the value of the second parameter is indicative of a ratio of the second quantity to a second reference value.

6. The apparatus of claim 4, wherein a change in at least one of the first and second parameters is indicative of movement by the object.

7. The apparatus of claim 6, wherein an increase in the value of the first parameter and a decrease in the value of the second parameter is indicative of rotation of the object.

8. The apparatus of claim 6, wherein:
an increase in the values of both the first and second parameters is indicative of lateral movement of the object; and
a decrease in the values of both the first and second parameters is indicative of lateral movement of the object.

9. The apparatus of claim 1, wherein the device is further to determine an indication of the movement of the object based at least in part on changes in successive values of a second parameter, the values of the second parameter derived by:
receiving a second quantity of responses from the first RFID tag by a second RFID reader during a second time period;
deriving the value of the second parameter, the value of the second parameter indicative of the second quantity; and
repeating the operations of receiving a second quantity and deriving the value of the second parameter to determine additional ones of the values for the second parameter for time periods successive to the second time period.

10. The apparatus of claim 9, wherein the device is to determine a likelihood of movement based on the first reader and the second reader being located at an approximate right angle from each other with respect to the RFID tag.

11. The apparatus of claim 9, wherein the value of the second parameter is indicative of a ratio of the second quantity to a second reference value.

12. The apparatus of claim 1, wherein the device is separate from the RFID reader and the device is to perform said deriving.

13. A method, comprising:
transmitting a plurality of signals to a radio frequency identification (RFID) tag;
receiving a plurality of responses from the RFID tag responsive to said transmitting;
deriving a parameter indicative of ratio of a quantity of the received responses to a reference number;
repeating the operations of transmitting, receiving, and deriving to produce a series of values for the parameter, each value associated with a separate period of time; and
determining a first indication of movement by an object comprising the RFID tag, based on differences in the values in the series.

14. The method of claim 13, wherein said determining comprises performing a statistical calculation on the sequence of values.

15. The method of claim 13, further comprising:
performing the operations of transmitting, receiving, deriving, and repeating, for a second RFID tag to determine a second indication of movement by the object; and
operating on the first and second indications to determine an indication of a type of movement by the object.

16. The method of claim 13, further comprising:
performing the operations of transmitting, receiving, deriving, and repeating, for the first RFID tag with a second RFID reader to determine a second indication of movement by the object; and
operating on the first and second indications to determine an indication of a type of movement by the object.

17. An article comprising
a machine-readable medium that provides instructions, which when executed by a computing platform, cause said computing platform to perform operations comprising:
operating on a first set of values for a first parameter, each of the values indicating a response rate for a quantity of responses received by a first radio frequency identification (RFID) reader from a first RFID tag on an object; and
examining differences between the values in the first set to determine a first indication of motion by the object.

18. The article of claim 17, wherein the operations further comprise:
operating on a second set of values for a second parameter, each of the values indicating a response rate for a quantity of responses received by the first RFID reader from a second RFID tag on the object;
examining differences between the values in the second set to determine a second indication of motion by the object; and
processing the first and second indications to determine an indication of a type of the motion by the object.

19. The article of claim 17, wherein the operations further comprise:
operating on a second set of values for a second parameter, each of the values indicating a response rate for a quantity of responses received by a second RFID reader from the first RFID tag on the object;
examining differences between the values in the second set to determine a second indication of motion by the object; and
processing the first and second indications to determine an indication of a type of the motion by the object.

20. The article of claim 17, wherein the operations further comprise:
operating on a second set of values for a second parameter, each of the values indicating a response rate for a quantity of responses received by the first RFID reader from a second RFID tag on the object;
examining differences between the values in the second set to determine a second indication of motion by the object;
operating on a third set of values for a third parameter, each of the values indicating a response rate for a quantity of responses received by a second RFID reader from the first RFID tag on the object;
examining differences between the values in the third set to determine a third indication of motion by the object;
operating on a fourth set of values for a fourth parameter, each of the values indicating a response rate for a quantity of responses received by the second RFID reader from the second RFID tag on the object; and
examining differences between the values in the fourth set to determine a fourth indication of motion by the object; and
processing the first, second, third and fourth indications of motion to determine a combined indication of motion by the object.
